(19) United States
(12) Patent Application Publication
(10) Pub. No.: US 2018/0272185 A1
(43) Pub. Date: Sep. 27, 2018

(54) EXERCISE DEVICE

(71) Applicant: Michael Stuart BARBER, New York, NY (US)

(72) Inventor: Michael Stuart BARBER, New York, NY (US)

(21) Appl. No.: 15/926,806

(22) Filed: Mar. 20, 2018

Related U.S. Application Data
(60) Provisional application No. 62/474,801, filed on Mar. 22, 2017.

(51) Int. Cl. A63B 23/14; A63B 21/00; A63B 21/015; A63B 21/045; A63B 23/16; A61H 1/02

(52) U.S. Cl. CPC A63B 23/14; A63B 21/00178; A63B 21/015; A63B 21/045; A63B 21/4035; A63B 21/4049; A63B 2213/00; A61H 1/0285; A63B 21/00069; A63B 21/00196; A61H 2001/0207; A61H 2201/1635; A63B 23/16

(57) ABSTRACT

An exercise device for exercising at least one of a human hand, wrist, and forearm, may include a pair of handles that rotatably mounted within sockets by exerting a force that can be adjusted. Further, levers may be pivotably mounted relative to handles to facilitate developing grip strength. Further, a vibrational force may be delivered to at least one of the handles to promote bone and muscle generation and inhibit their loss.

### CROSS REFERENCE TO RELATED APPLICATIONS

This application relates to and claims priority from U.S. Prov. App. Ser. No. 62/474,801 which was filed on Mar. 22, 2017, the entire contents of which are hereby incorporated herein by reference.

### BACKGROUND OF THE INVENTION

### Field of the Invention

The present invention relates generally to an exercise device that facilitates strengthening of hand, wrist, and forearm muscles.

### Description of the Related Art

As shown in FIGS. 1 and 2, the human hand typically includes a thumb and four fingers including index, middle, ring, and pinky fingers, as well as a thumb (FIG. 1). Movement of the hand's fingers is controlled by various hand, wrist, and forearm muscles, as shown in FIG. 2.

Exercise of the hand, wrist, and forearm muscles can prevent or treat conditions of the hand, wrist, and forearm. Such conditions may include, for example, tendonitis, stroke rehabilitation, golfer's elbow, tennis elbow, carpal tunnel syndrome, sprain/strain/fracture rehabilitation, osteoarthritis, osteoporosis, DeQuervain's Syndrome, RSI's (repetitive stress injuries) and neuropathies.

### ASPECTS AND SUMMARY OF THE INVENTION

The present invention relates to an exercise device that facilitates strengthening of hand, wrist, and forearm muscles.

Disclosed herein is an exercise device for exercising at least one of a human hand, wrist, and forearm. Generally, the exercise device may include a pair of handles that rotatably mounted within sockets by exerting a force that can be adjusted. Further, levers may be pivotably mounted relative to handles to facilitate developing grip strength. Further, a vibrational force may be delivered to at least one of the handles to promote bone and muscle generation and inhibit their loss.

The exercise device may include a mount which may be placed atop a table or other surface such that a user may use the device while in a seated position.

The exercise device may facilitate exercise of the wrist muscles. In particular, handles operably connected to the mount may be gripped by a user and the user may rotate the handles relative to the mount such that the wrist muscles may be exercised. For example, the mount be operably coupled or connected to a first and a second socket which may be positioned such that they are co-linear to one another. The first and second sockets may be rotatable relative to one another. Each of the sockets may receive a ball that coupled to the end of a handle such that the handles may be rotated relative to one another. Each of the sockets may include a cut-out portion or groove which may permit the the handle to be rotated a greater extent in the area of the groove than in the portions of the socket that do not include the groove. A tensioning knob may be configured to frictionally engage the ball and/or deform the socket such that the socket itself resists rotation of the ball secured within the socket. Rotation of the knob in a first direction may resist rotation of the ball within the socket, whereas rotation of the knob in a second direction opposite that of the first direction may make relative rotation of the ball and the socket easier.

Levers that are rotatably coupled to each handle may facilitate exercise of flexor muscles controlling the four fingers (i.e., index, ring, middle, and pinky fingers) of the hands. In particular, the device may include: a first lever being pivotably secured to the first handle, a first cable tensioning the first lever toward an uncompressed condition, the first cable being tensioned by a spring having an adjustable tension force; and a second lever being pivotably secured to the second handle, a second cable tensioning the second lever toward an uncompressed condition, the second lever being tensioned by a spring having an adjustable tension force.

2. The first and second cables may be operatively coupled to at least one tension spring, wherein the tension spring can be adjusted such that a tensioning force exerted by the at least one tension spring upon the first and second cables is correspondingly adjusted. The at least one tension spring may be secured at a first end to the mount and at a second end to an adjustable tensioning member, the adjustable tensioning member including a screw that is rotatable to adjust a pulling force exerted on the at least one tension spring, an increase in the pulling force causing a corresponding increase in the tensioning force. The at least one vibrator may be mounted to each of the first and second handles. At least one vibrator may be mounted to the mount. At least vibrator may be mounted to each of the sockets. A vibrator may be configured to selectively deliver a vibrational force to at least one of the first and second handles. The vibrator may include an oscillating weight. The vibrator may be electrically coupled to a power source which may be an internal battery or an external power source. The system may further comprise a computer and a memory as would be understood in the art such that a vibrational force may be delivered in accordance with a predetermined pattern or intervals.

The above and other aspects, features and advantages of the present invention will become apparent from the following description read in conjunction with the accompanying drawings, in which like reference numerals designate the same elements.

### BRIEF DESCRIPTION OF THE DRAWINGS

A further understanding of the present invention can be obtained by reference to a preferred embodiment set forth in the illustrations of the accompanying drawings. Although the illustrated preferred embodiment is merely exemplary of methods, structures and compositions for carrying out the present invention, both the organization and method of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

For a more complete understanding of the present invention, reference is now made to the following drawings in which:

FIG. 1 is a front or palm-side view of a human hand identifying the anatomy of the hand.

FIG. 2 is a back or dorsal side view of a human hand identifying muscle structures of the hand.

FIG. 3 is a rear perspective view of an exercise device.

FIG. 4 is a front perspective view of the exercise device of FIG. 3.

FIG. 5 is a partial bottom view of the exercise device of FIG. 3.

FIG. 6 is a bottom view of the exercise device of FIG. 3.

FIG. 7 is a partial bottom perspective view of the exercise device of FIG. 3.

FIG. 8 is a partial perspective view of the exercise device of FIG. 3.

FIG. 9 is a partial top view of the exercise device of FIG. 3.

FIG. 10 is a partial back view of the exercise device of FIG. 3.

### DETAILED DESCRIPTION OF THE PREFERRED EMBODIMENTS

As required, a detailed illustrative embodiment of the present invention is disclosed herein. However, techniques, systems, compositions and operating structures in accordance with the present invention may be embodied in a wide variety of sizes, shapes, forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein, which define the scope of the present invention.

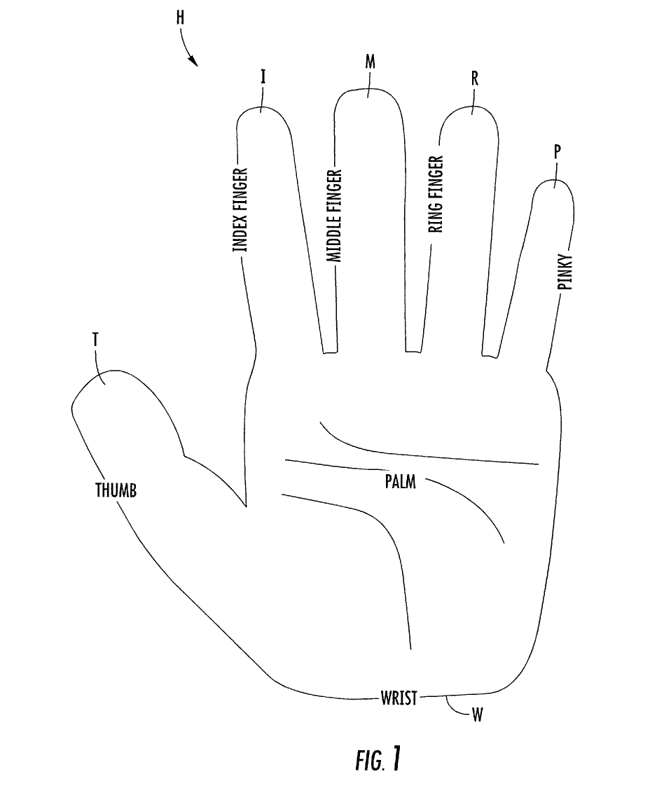

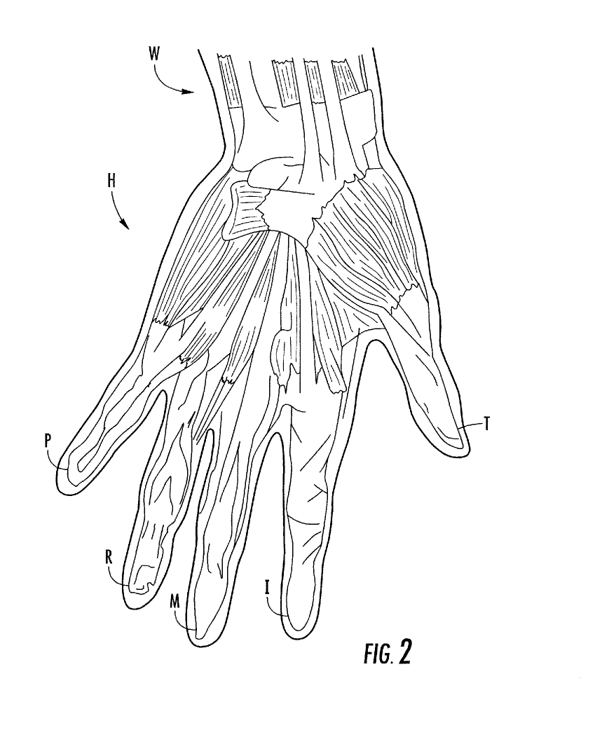

As shown in FIGS. 1-2, the anatomy of the human hand is shown. A typical human hand includes a wrist, a palm, a thumb, and fingers including an index finger, middle finger, ring finger, and pinky finger. Movement of the hand H is facilitated by various muscles including flexor muscles for moving the wrist W and fingers of the hand, as well as, muscles called lumbricals I-IV for each of the four fingers (i.e., index finger I, middle finger M, ring finger R, and pinky finger P), as well as muscles for the movement of the thumb T. Exercise of these muscles is critical to prevent or recover from various hand injuries.

Reference to the hand and its structures is made herein to further facilitate an understanding of an exercise device 100 described hereinbelow.

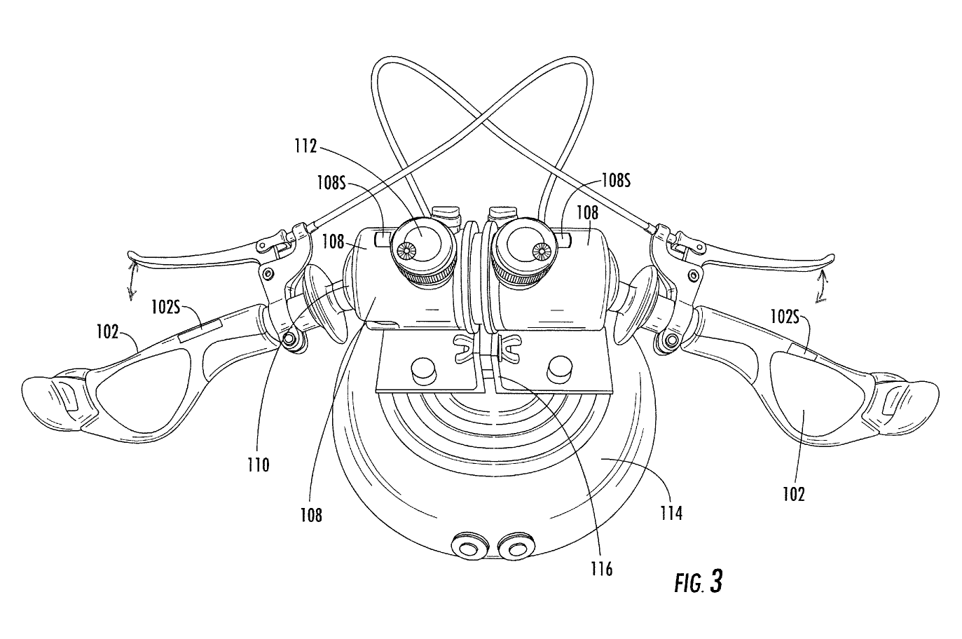

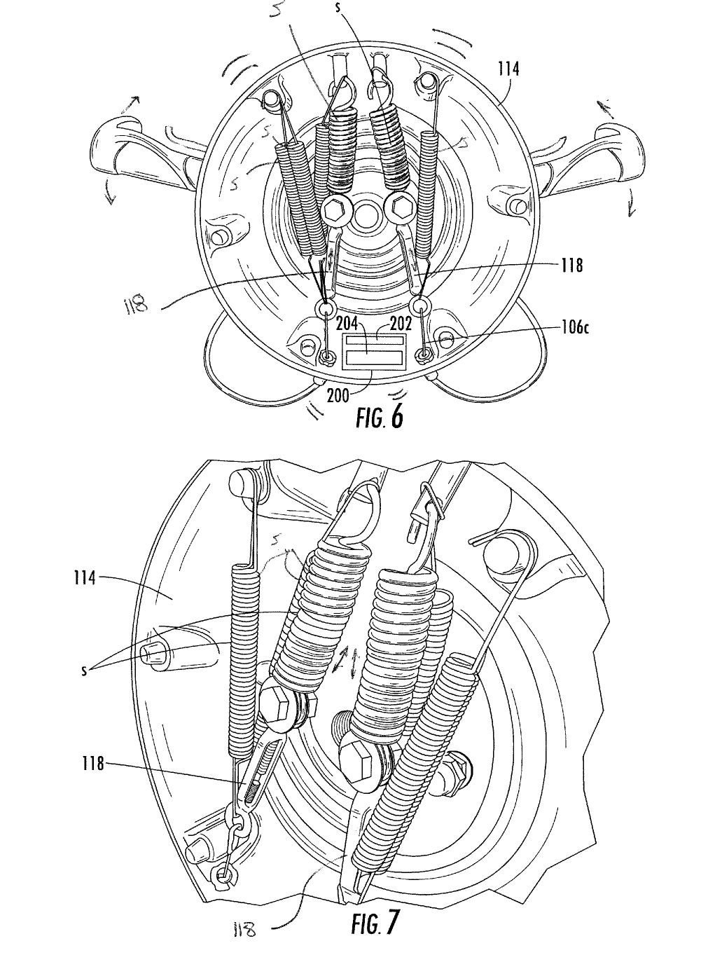

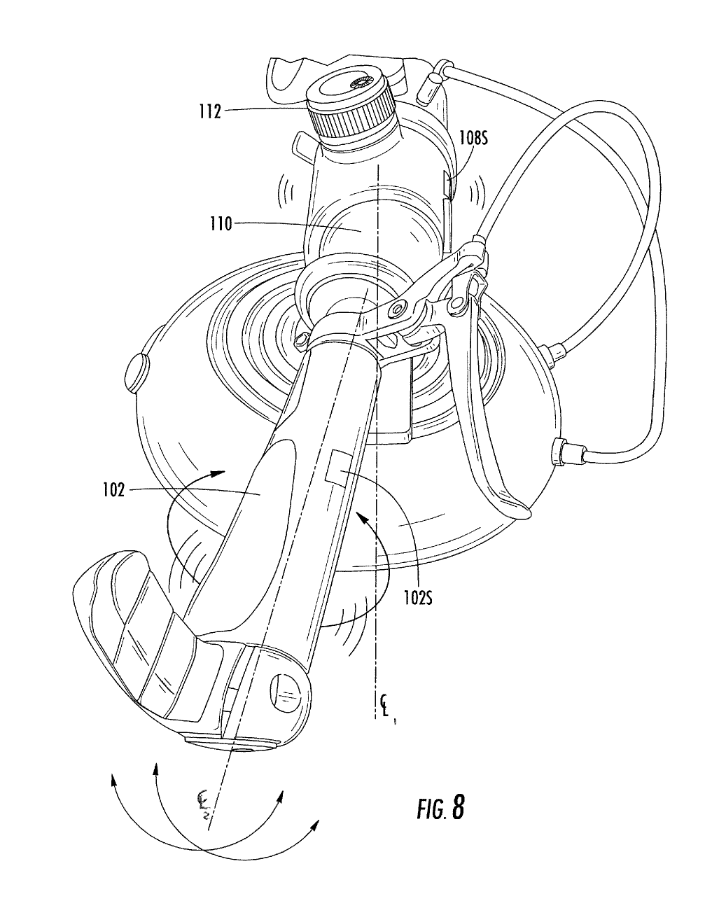

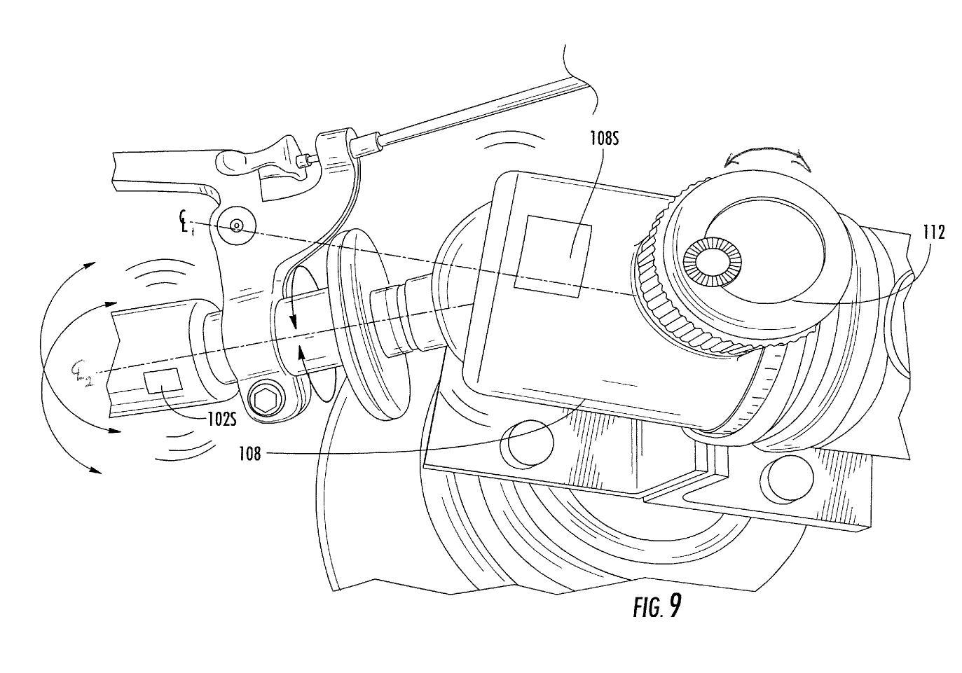

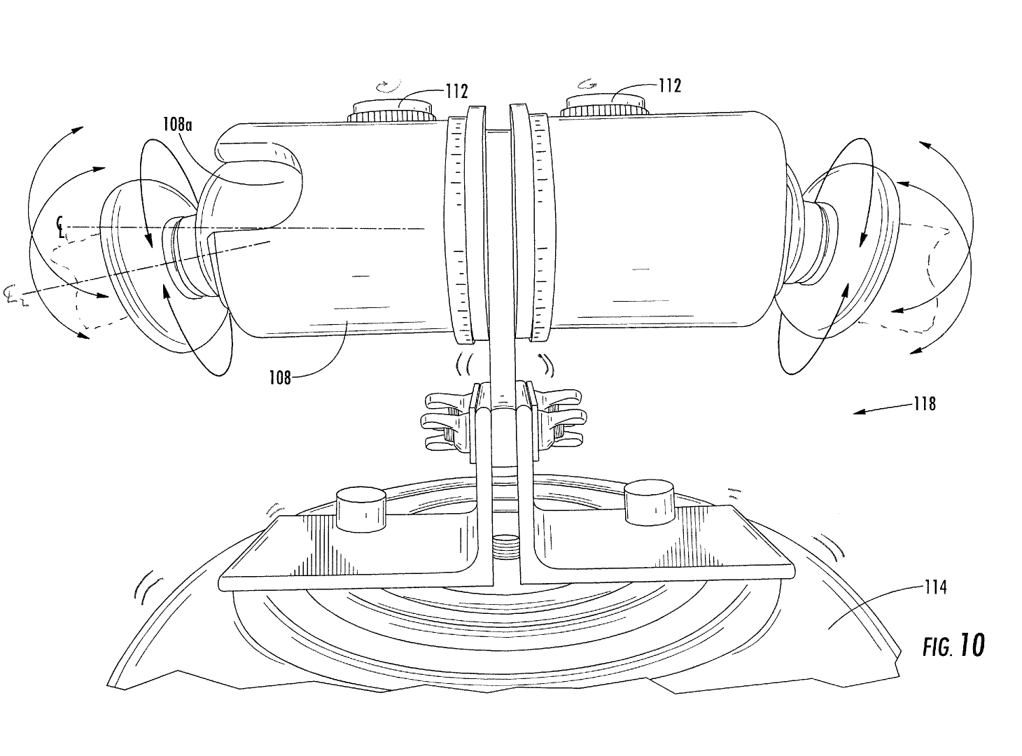

Referring to FIGS. 3-10, the exercise device 100 will now be described. The exercise device 100 includes handles 102 which may be of an ergonomic shape to facilitate grasping by a user. The handles 102 may include a rubberized, compressible, and/or textured surface for the comfort of the user. The handles 102 may be generally placed on opposing sides of the device 100 such that one handle is provided for the left hand while another is provided for the right hand. Each handle 102 may include a lever 104. During use, while the user grasps the handle 102 by gripping the handle 102 between the palm of the hand and the thumb, the user's remaining four fingers gripping the lever 104, the lever 104 may be squeezed toward the handle 102 such that the muscles of the fingers and grip strength may be improved. Cables 106c, which may be encased or housed within tubes 106, for protection may tension the levers 104 away from a compressed condition.

The ball 110 and the socket 108 form a ball joint such that each of the handles 102 may be rotatable relative to a socket 108 which is configured to receive a ball or sphere 110 fitted or secured to an end of the handle 102. The socket may include a groove or a cut 108a (FIG. 10) to facilitate a greater degree of rotation along a first direction than in another. The cut 108a may be on one side of the socket 108 or may be for example on opposing sides. Rotation of the ball 110 relative to the socket 108 may be resisted by adjusting a tensioning knob 112. The sockets 108 may be secured to a support 116 which may be secured to a mount 114. The sockets 108 may be rotatable relative to the support 116 such that the sockets 108 may be secured in a desired position relative to the support 116. The support 116 may also be secured at a desired angled relative to the mount 114. The tensioning knob 112 may be rotated to frictionally resist movement of the ball 110 within the socket 108 by a desired amount. That is, by rotating the knob 112 in a first direction, pivotal movement of the ball 110 within the socket 108 may become more difficult whereas rotation of the knob 112 in a second direction opposite that of the first direction may make movement of the ball 110 within the socket 108 less difficult.

Mount 114 is a securing base element and is positionable in different locations to secure the support 116. For example, mount 114 may include weights (not shown), a suction-cup-system arrangement (allowing securment to a glass surface, wall, window, or door) with the suction cup-system including at least one suction cup and a suction cup release mechanism, a magnetic fixing securing arrangement (magnetic features in base 114 securing to a ferrous support member (e.g., metal desk or wall), or a clamping arrangement for fixing to a secure base (base can be horizontal, vertical, or slanted). The clamping arrangement may include toggle clamps, threaded clamps, elastomeric clamps, and other clamping means.

Referring to FIGS. 5-7, the cables 106c may be adjustably tensioned such that the amount of grip strength needed to compress the levers 104 may be adjusted. As shown, the cables 106c may hook onto adjustable tensioning members 118 that couple the cables 106c to springs S that are secured to the underside of the mount 114. The number of springs S as well as the tensioning force of particular springs may be selected to correspond to a desired tensioning force on the levers 104. Further, the tensioning members 118 may be adjusted to give more or less slack such that a greater or lesser pulling force is applied to the spring S. The greater the force applied to the spring S, that is the greater the spring S is already tensioned, the more difficult it may be to further stretch the spring S and the greater the grip strength needed to compress the lever 104.

It is to be understood that although springs S are shown and described herein, that other means of generating resistive forces that may be additionally or alternatively used may include, for example, magnets and magnetic resistance means and are thus also within the scope and spirit of the present disclosure. Also, although the springs S are shown as being manually adjusted, it is to be understood that electric motors, for example, may be operatively coupled to the springs to effect an automatic adjustment of the tensioning forces of the springs S.

During use, a user may grip the opposing handles 102 by making a fist around the handles 102 with the palm of the hand resting on each handle 102. The user may extend the fingers (i.e., the index, middle, ring, and pinky fingers) toward levers 104 and may squeeze the levers 104 toward the handles 102. This squeezing motion may be particularly useful for exercising the flexor and lumbrical muscles of controlling the index, middle, ring, and pinky fingers. The squeezing of the levers 104 toward the handles 102 may be opposed by the cables 106c which are tensioned by springs S having a resistance which may be set by the user.

In addition, the user may rotate the handles 102 to exercise the wrist muscles including for example the flexor longus, flexor carpi radials, flexor carpi ulnaris, and flexor retinaculum muscles. The extent by which the handles 102 may rotate may be set or varied the relative positioning of the socket 108 with respect to the ball 110 such that the handle 102. In particular, the handle 102 may be able to rotate a greater extent where the cutout or groove 108a is positioned in the socket 108. The grooves 108a of the sockets 108 may be positioned such that the handles 102 may rotate to the greatest extent when the hands are rotated in opposing directions.

Further, during use, a user may rotate tensioning knob 112 to cause rotation of the handles 102 to be resisted such that the user needs to exert a greater force to cause the handles 102 to rotate. The handles 102 may be rotated relative to the sockets 108 such that they can be angled relative to one another relative to the axis extending lengthwise along the sockets 108 in any radial relative to the circumference of the socket 108 until the interaction of the socket 108 and the handle 102 inhibit further relative rotation.

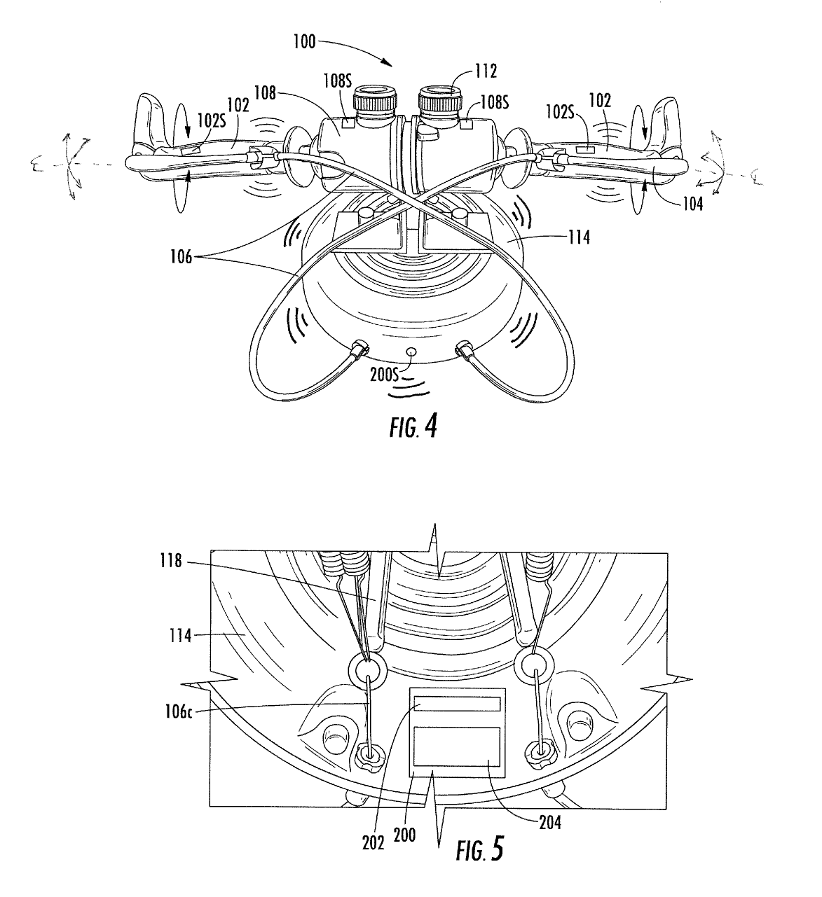

As shown best in FIG. 4, the handles 102 may be rotated along the directional arrows as shown relative to the sockets 108, and as shown best in FIG. 8, each of the handles 102 may also be pivoted relative to the socket 108 such that the longitudinally extending axis of the handle 102 form a desired angle relative to the centerline CL extending through the socket 108. If in a desired position, the user may use the tensioning knob 112 to set the angular position of the handle 102. The tensioning knob 112 may frictionally interact with the ball 110 or may cause the socket 108 to deform somewhat such that the socket 108 frictionally interacts with the ball 110 to a degree set by the user.

During use, the user may place the exercise device 100 on a table top or counter (not shown) such that the user may be seated while exercising his hand and wrist muscles.

In addition, at least one vibrating means may be provided to facilitate vibration, which may facilitate further exercising of the hands. In the figures, vibrational markings indicate the vibrational movement of the components of the system when the vibrational means are actuated. During use, a vibrational force may be delivered to at least one of the first and second handles. Small vibrations can help inhibit bone and muscle loss and are therefore beneficial to users who may be suffering from bone loss and/or muscle atrophy and may also promote muscle and bone generation.

As shown in FIG. 3, vibrating means may be provided on or within the handles 102 and/or the sockets 108 and/or the mount 114. The handles 102 may include a vibrator 102S and the sockets 108 may include a vibrator 108S. Each of the vibrators 102S and 108S may include a power source (e.g., a battery) and/or may be electrically coupled to an external power source, and may also include switch that may be a capacitive touch switch for example. As shown in FIG. 5, the mount 114 may include a vibrator 200 which may be disposed on an inner surface of the mount 114 and may include a vibrating a power source 202 and a vibrating means 204. The power source 202 may be an internal battery and/or the vibrating means 204 may be electrically coupled to an external power source. A switch 200S (shown in FIG. 4) may be exposed on an exterior of the mount 114. The vibrating means 204 and the vibrators 102S and 108S may be any suitable vibrating means including, for example, a mechanical oscillator, a vibrating plate, a vibrational motor (which may be created by the imbalance of a counterweight), an eccentrically mounted weight, sonic vibrating means, and/or the like or any other suitable means for generating a vibrational force or effect. Further, the intensity of the vibrations produced by any of the vibrators 200, 102S, and 108S may be adjusted by the user or in response to particular user actions or exercises being performed.

Operation of the vibrators 200, 102S, and 108S may be controlled via one or more computers. For example, the vibrators 200, 102S, and 108S may perform a sequence of operations according to a predetermined instruction such as for example, vibrating for a predetermined duration of time and/or intensities. Also for example, the duration of intensities may be based on a predetermined pattern, e.g., faster vibration for 10 seconds, followed by slower vibration for 5 seconds, and the like. Moreover, various sensors (not shown) operatively coupled to the handles 102, levers 104, as well as the vibrators 200, 102S, and 108S, for example, may monitor and/or record the user's use of the system 100 such that progress may be tracked and/or recorded. Further, the system 100 and its various components may be coupled to one or more external apps or accessories, including, for example a smartphone application. Such an operative coupling may be facilitated via a Bluetooth or WiFi connection and may facilitate the user setting the intensity of vibrations, for example. The system 100 may include a computer and/or communication devices/interfaces as would be understood in the art.

Reference will now be made in detail to several embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, up, down, over, above, below, etc., or motional terms, such as forward, back, sideways, transverse, etc. may be used with respect to the drawings. These and similar directional terms should not be construed to limit the scope of the invention in any manner.

### GLOSSARY OF REFERENCE NUMERALS

100: Exercise device
102: Handles
102S: Vibrator
104: Levers
106: Tubes
106c: Cables
108: Socket
108a: Groove
108S: Vibrator
110: Ball
112: Tensioning knob
114: Mount
116: Support
S: Spring
118: Tensioning member
200: Vibrator
200S: Switch
202: Power source
204: Vibrating means

Having described at least one of the preferred embodiments of the present invention with reference to the accompanying drawings, it is to be understood that such embodiments are merely exemplary and that the invention is not limited to those precise embodiments, and that various changes, modifications, and adaptations may be effected therein by one skilled in the art without departing from the scope or spirit of the invention as defined in the appended claims. The scope of the invention, therefore, shall be defined solely by the following claims. Further, it will be apparent to those of skill in the art that numerous changes may be made in such details without departing from the spirit and the principles of the invention. It should be appreciated that the present invention is capable of being embodied in other forms without departing from its essential characteristics.

What is claimed is:

1. An exercise device for exercising at least one of a human hand, wrist, and forearm, comprising:
a mount;
a first socket and a second socket secured to the mount and being generally colinear and rotatable relative to one another;
a first handle and a second handle, each handle being secured to a ball at an end thereof, the ball being rotatably received within respective ones of the first and second sockets, the rotation of the ball relative to the socket being within a predetermined range along at a first and a second axis of rotation;
a tensioning knob being configured to apply a resistive force the ball to resist rotational movement of the ball within the socket, the resistive force corresponding to a frictional force between the ball and the socket, rotation of the knob in a first direction causing a greater frictional force and rotation of the knob in a second direction causing a lesser frictional force;
a first lever being pivotably secured to the first handle, a first cable tensioning the first lever toward an uncompressed condition, the first cable being tensioned by a spring having an adjustable tension force; and
a second lever being pivotably secured to the second handle, a second cable tensioning the second lever toward an uncompressed condition, the second lever being tensioned by a spring having an adjustable tension force.

2. The exercise device of claim 1, wherein the first and second cables are operatively coupled to at least one tension spring, wherein the tension spring can be adjusted such that a tensioning force exerted by the at least one tension spring upon the first and second cables is correspondingly adjusted.

3. The exercise device of claim 2, wherein the at least one tension spring is secured at a first end to the mount and at a second end to an adjustable tensioning member, the adjustable tensioning member including a screw that is rotatable to adjust a pulling force exerted on the at least one tension spring, an increase in the pulling force causing a corresponding increase in the tensioning force.

4. The exercise device of claim 1, further comprising at least one vibrator mounted to each of the first and second handles.

5. The exercise device of claim 1, further comprising at least one vibrator mounted to the mount.

6. The exercise device of claim 1, further comprising at least vibrator mounted to each of the sockets.

7. The exercise device of claim 1, further comprising a vibrator, the vibrator being configured to selectively deliver a vibrational force to at least one of the first and second handles.

8. The exercise device of claim 7, wherein the vibrator includes an oscillating weight.

9. The exercise device of claim 8, wherein the vibrator includes a power source, the power source being a battery.

10. The exercise device of claim 7, further comprising a computer and a memory and wherein the vibrational force is deliverable in accordance with a predetermined pattern or intervals.
